(19) United States
(12) Patent Application Publication
(10) Pub. No.: US 2005/0252050 A1
(43) Pub. Date: Nov. 17, 2005

(54) License plate frame

(76) Inventor: Douglas A. Menke, West Chester, OH (US)

Correspondence Address: JAMES RAY & ASSOCIATES, 2640 PITCAIRN ROAD, MONROEVILLE, PA, 15146, US

(21) Appl. No.: 11/088,516

(22) Filed: Mar. 24, 2005

Related U.S. Application Data
(60) Provisional application No. 60/561,025, filed on Apr. 9, 2004.

(51) Int. Cl. G09F 7/00

(52) U.S. Cl. 40/209

(57) ABSTRACT

A frame for a license plate of a motor vehicle is attached to the license plate without fasteners. A rear surface of the frame includes a plurality of tabs which cage the peripheral edge of the license plate enabling secure attachment of the frame.

### CROSS-REFERENCE TO RELATED APPLICATIONS

This application is related to and claims priority from U.S. Provisional Patent Application Ser. No. 60/561,025 filed on Apr. 9, 2004.

### FIELD OF THE INVENTION

The present invention relates, in general, to a frame for a license plate of a motor vehicle, motorcycle and the like and, more particularly, this invention relates to the license plate frame which can be attached without fasteners.

### BACKGROUND OF THE INVENTION

As is generally well known in the automotive industry, license plate frames are used on motor vehicles to protect the surface of the license plate from various contamination elements such dirt, tar and oil present during driving conditions, accent the license plate with ornamental designs and various colors to suit individual owner taste and serve as a marketing tool for automotive dealers.

The license plate frame may be attached after the license plate has been installed or the owner may replace the existing license plate frame with one of a different style during ownership of such motor vehicle.

Prior art license plate frames are placed over the license plate and secured with the same fasteners which are used for securing the license plate in the license plate well at the vehicle rear or to the license plate support at the vehicle front bumper.

It is well known that the fasteners are prone to corrosion which increases the effort to install or replace the prior art license plate frames.

U.S. Pat. No. 4,270,287 to Gimbel teaches a decorative peripheral frame consisting from four individual sections mounted at each corner and applied to the license plate with use of adhesives. The effort to cut and taper such four individual sections is time consuming and use of adhesives requires unnecessary cleaning of the license plate after frame removal.

Therefore, there is a need for an improved license plate frame for a motor vehicle which is relatively easy to install.

### SUMMARY OF THE INVENTION

In a first aspect, the invention provides a frame for a license plate of a motor vehicle which includes a frame member having a predetermined shape and a predetermined thickness and having a front surface and an opposed rear surface. An aperture extends through the front and the rear surfaces and forms a peripheral edge. A predetermined plurality of L-shaped tabs are disposed on the rear surface of the license plate and cage a predetermined portion of a peripheral edge of the license plate against the rear surface of the frame for attachment of the frame to the license plate.

According to another embodiment, the flexible frame includes a pair of opposed first members and a pair of opposed second members each joining opposed ends of each of the pair of the first members. Such pair of first members and the pair of second members form an aperture within the frame. A peripheral cavity having a predetermined thickness and a predetermined depth is formed in each of the pair of the first members and the pair of the second members. The cavity is open in a direction of the aperture. The frame is expandable from a first position being smaller than the license plate to a second position wherein an outer edge of the license plate is disposed within the cavity for attachment of the frame to the license plate. Upon frame attachment, the aperture exposes a predetermined portion of the license plate.

In yet another embodiment of the invention, the frame includes a flexible continuous member having a first leg and an opposed second leg. The flexible continuous member is shaped to surround a peripheral edge of the license plate with the first leg engaging one surface of the license plate and with the second leg engaging the opposed surface of the license plate.

### OBJECTS OF THE INVENTION

It is, therefore, one of the primary objects of the present invention to provide a license plate frame for a motor vehicle.

Another object of the present invention is to provide a license plate frame which does not require the use of fasteners or adhesives for installation.

Yet another object of the present invention is to provide a license plate frame which is decorative.

A further object of the present invention is to provide a license plate frame which is relatively easy to install.

Additional object of the present invention is to provide a license plate frame which protects the surface of the license plate.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective expanded view of a license plate frame of one embodiment of the present invention;

FIG. 2 is a cross-sectional view of the license plate frame along the lines 2-2 of FIG. 1;

FIG. 3 is a planar view of a license plate frame of another embodiment of the present invention;

FIG. 4 is a side view of the license plate frame FIG. 3; and

FIG. 5 is partial perspective view of yet another embodiment of the present invention.

### BRIEF DESCRIPTION OF THE VARIOUS EMBODIMENTS OF THE PRESENT INVENTION

Prior to proceeding to the more detailed description of the present invention, it should be noted that, for the sake of clarity and understanding, identical components which have identical functions have been identified with identical reference numerals throughout the several views illustrated in the drawing figures.

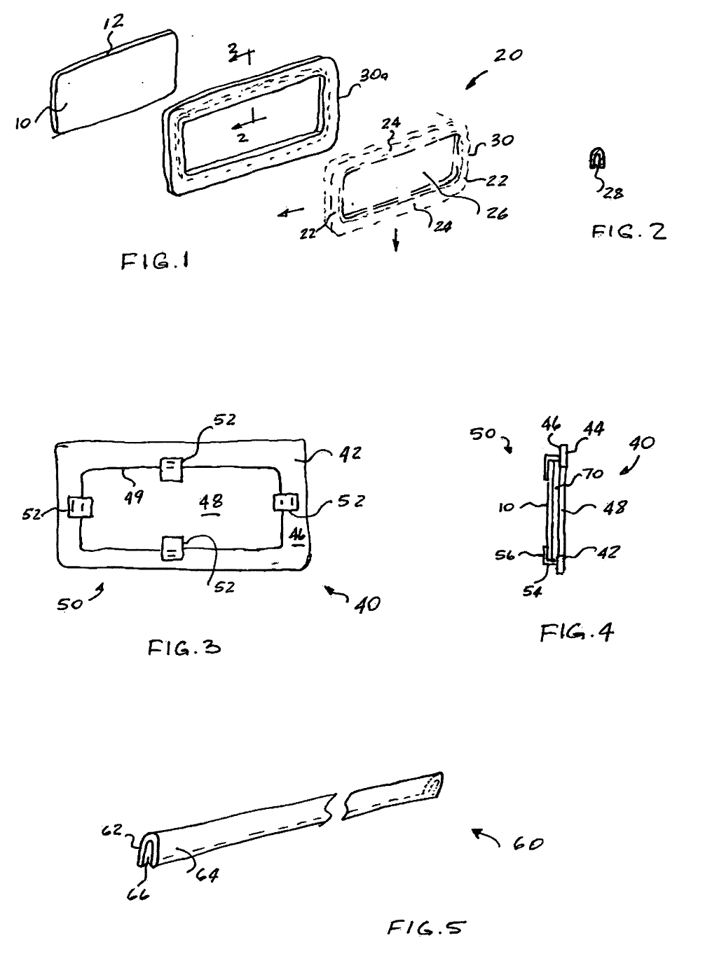

Reference is now made, more particularly, to FIGS. 1 and 2. Illustrated therein is one form of a license plate frame, generally designated 20, for attachment to a license plate 10 of a motor vehicle which is not shown but well known in the art. In this embodiment, the frame 20 has a pair of first opposed portions 22 and a pair of second opposed portions 24 integrally joined at ends to form a peripheral frame 20 having an aperture 26 exposing a predetermined portion of the license plate 10 upon attachment of the frame 20 thereto. Each first and second portions 22 and 24 respectively have a predetermined width which is preferably identical and are provided with a peripheral cavity 28 of a predetermined thickness and a predetermined depth, best shown in FIG. 2, which is disposed adjacent the aperture 26.

The frame 20 is manufactured from a flexible and expandable material enabling such frame 20 to fit the license plate 10 of various sizes. During installation, the frame 20 is expanded from a first position shown at 30 in FIG. 1, wherein the frame 20 is of an original size which is smaller than the size of the license plate 10, to a second position shown at 30a in FIG. 1, wherein the frame 20 is expended with the aperture 26 being slightly larger then a size of the license plate 10. The frame 20 is than allowed to contract with the peripheral cavity 28 engaging and overlapping a peripheral edge 12 of the license plate 10 thus securing the frame 20 thereon.

Preferably, the material of such frame 20 is a polymer and it is further preferred that such polymer is an elastomer. It will be appreciated that such expandable frame 20 may be manufactured by a well known molding or vulcanization processes.

The frame 20 may be manufactured from a material having a predetermined color and may have a predetermined indicia (not shown) disposed on at least a portion of such first and second portions 22 and 24 respectively.

Attention is now directed to FIGS. 3-4, wherein there is illustrated another embodiment of a license plate frame, generally designated 40. The frame 40 has a member 42 of a predetermined shape and a predetermined thickness with a front surface 44 and of an opposed rear surface 46. Preferably, such rear surface 46 is planar. The member 40 has an aperture 48 extending through the front and rear surfaces 44 and 46 respectively and forming a peripheral edge 49. The size of the aperture 48 is generally smaller than the size of the license plate 10 with the peripheral edge 49 being disposed at a predetermined distances form the peripheral edge 12 of such license plate 10.

The rear surface 46 is provided with means, generally designated 50, for secure attachment of the frame 40 to the license plate 10. In the preferred embodiment, such means 50 is a predetermined plurality of tabs 52 disposed at a predetermined locations around the peripheral edge 49. Each tab 52 has a first element 54 of a predetermined width and a predetermined height disposed at a predetermined distance from the peripheral edge 49 and outwardly extending from the rear surface 46 and a second element 56 extending from an open end of the first element 54 toward, and preferably beyond, the peripheral edge 49 of the aperture 48 and forming an L-shaped tab 52 for caging at least a predetermined portion of the peripheral edge 12 of the license plate 10. Preferably, an open end of the second element 56 is angled toward the rear surface 46 of the member 42.

Alternatively, at least the first element 54 may be extended a predetermined portion of the peripheral edge 49 for increased engagement of the means 50 with the license plate 10.

It will be appreciated that such frame 40 may be installed by first engaging a portion of the peripheral edge 12 of the license plate 10 and then sliding the frame 40 over the surface of the license plate 10 to securely engage the peripheral edge 12 thereof with such predetermined plurality of tabs 52.

The frame 40 of such embodiment may be manufactured from either metal or polymer material and preferably it is manufactured from polymer material. Alternatively, the frame 40 may be manufactured from a combination of metal and polymer materials.

Refer now to FIG. 5. Shown therein is still yet another embodiment of a license plate frame 60 manufactured from a flexible material and having a first leg 62 and a second leg 64 generally forming a U-shape in cross-sectional configuration with a groove 66 disposed between such first and second legs 62 and 64 respectively. Preferably, such first and second legs 62 and 64 respectively are angled to at least partially close an open edge of the frame 40. Such flexible frame 60 may be manufactured as a continuous strip and installed by first engaging a portion of the peripheral edge 12 of the license plate 10 into the groove 66 and then surrounding such peripheral edge 12 of the license plate 10 for attachment thereto.

It will be apparent to those skilled in the art that a transparent cover 70, preferably manufactured from a flexible material and best shown in FIG. 4 may be used with the license plate frame of the above embodiments by first being placed against a front surface of the license plate 10 for protecting thereof from environmental elements. Advantageously, such transparent cover 70 will cover fasteners (not shown) used for attachment of the license plate minimizing their corrosion.

Furthermore, it will be apparent to those skilled in the art that the member 42 of the frame 40, shown in FIGS. 3 and 4, may be manufactured from a predetermined transparent material omitting the aperture 48 and thus covering an entire front surface of the license plate 10.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. A flexible frame for a license plate of a motor vehicle, said frame comprising:
(a) a pair of opposed first members;
(b) a pair of opposed second members each joining opposed ends of each of said pair of said first members;
(c) an aperture formed by said pair of first members and said pair of second members; and
(d) a peripheral cavity having a predetermined thickness and a predetermined depth and formed in each of said pair of said first members and said pair of said second members, said cavity open in a direction of said aperture, whereby said frame is expandable from a first position being smaller than said license plate to a second position wherein an outer edge of said license plate is disposed within said cavity for attachment of said frame thereto, said aperture exposing a predetermined portion of said license plate.

2. The frame according to claim 1, wherein a material of said frame is an expandable polymer.

3. The frame according to claim 1, wherein said frame has a predetermined color.

4. The frame according to claim 1, wherein said frame has a predetermined indicia disposed on at least a portion of said first and second members.

5. The frame according to claim 1, wherein said frame includes a transparent cover engageable with a front surface of said license plate.

6. A frame for a license plate of a motor vehicle, said frame comprising:
(a) a member having a predetermined shape and a predetermined thickness and having a front surface and an opposed rear surface; and
(b) means engageable with said rear surface of said member and a predetermined portion of a peripheral edge of said license plate for attachment of said frame thereto.

7. The frame according to claim 6, wherein said means for attachment includes a predetermined plurality of elements disposed in a predetermined pattern, each having a first portion of a predetermined width and a predetermined height and outwardly extending from said rear surface of said member and a second portion extending from an end of said first portion, said first and said second portions caging said license plate against said rear portion of said member.

8. The frame according to claim 7, wherein said second portion is angled toward said rear surface of said member.

9. The frame according to claim 6, wherein a material of said frame is one of a metal, a polymer and a combination thereof.

10. The frame according to claim 9, wherein said material is a polymer.

11. The frame according to claim 10, wherein said polymer is transparent.

12. The frame according to claim 6, wherein said frame includes an aperture having a predetermined shape and extending through said front and said rear surface of said member, said aperture exposing a predetermined portion of said license plate, whereby said means for attachment is disposed at a predetermined distance from a peripheral edge formed by said aperture.

13. The frame according to claim 12, wherein said frame includes a transparent cover disposed intermediate said rear surface of said member and a front surface of said license plate.

14. A frame for a license plate of a motor vehicle, said frame comprising a flexible continuous member having a first leg and an opposed second leg, said flexible continuous member shaped to surround a peripheral edge of said license plate, said first leg engageable with one surface of said license plate and said second leg engageable with an opposed surface of said license plate.
